(19) United States
(12) Patent Application Publication
(10) Pub. No.: US 2003/0109939 A1
(43) Pub. Date: Jun. 12, 2003

(54) Method for establishing a table of correction values and sensor signal and a sensor module

(76) Inventors: Jochen Burgdorf, Offenbach (DE); Helmut Fennel, Bad Soden (DE); Ralf Herbst, Nast?auml;tten (DE); Rainer Kitz, Nidderau (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/169,437

(22) PCT Filed: Dec. 21, 2000
(86) PCT No.: PCT/EP00/13064

(30) Foreign Application Priority Data
Jan. 5, 2000 (DE) 100 00 166.1

(51) Int. Cl. G05B 13/02; G05B 11/01

(52) U.S. Cl. 700/38; 700/46; 700/71

(57) ABSTRACT

A system for establishing a table of correction values for detecting deviations from zero in a sensor module of a vehicle, wherein a sensor sensing the movement of the vehicle a sensor for sensing the temperature of the vehicle movement sensor and is provided, and a method for determining a corrected sensor signal and a sensor module for determining a corrected sensor signal.

### TECHNICAL FIELD

The present invention generally relates to systems for signal conditioning and more particularly relates to systems for establishing a table of correction values for detecting deviations from zero in a sensor output signal.

### BACKGROUND OF THE INVENTION

Systems for regulating or controlling different vehicle-dynamics quantities of an automotive vehicle have become increasingly complex because new functions are implemented in the automotive vehicle more and more frequently. For example, systems for brake regulation and/or control (ABS), systems for traction slip control (TCS), systems for steering control and/or regulation, suspension control systems, driving dynamics control systems (ESP), and engine management systems are known in the art.

It is common for the above-referenced to require information about the movement of the vehicle relative to the road. Mainly, it is necessary to measure the longitudinal movement, the transverse movement, and the yawing movement of the vehicle by means of appropriate sensors.

Rotational speed sensors and yaw rate sensors which utilize the Coriolis force are employed to determine the movement about the vertical axis of the vehicle. In general, sensors of this type possess a movable mechanic structure which includes an electric-mechanic transducer induced to a periodic vibration. When a rotation about an axis vertically to the induced vibration is imparted to the sensor, the movement of the vibration will cause a Coriolis force which is proportional to the measured quantity, i.e., the angular speed. The Coriolis force will induce in a mechanic-electric transducer a second vibration which is orthogonal in relation to the induced vibration. This second vibration can be sensed by different measuring methods, and the sensed quantity is used as a standard for the yaw rate that acts on the yaw rate sensor.

The sensors for yaw rate, longitudinal and transverse accelerations used in a sensor module (PC/EP99/017585) suffer from operating point or zero offset errors which, apart from manufacturing tolerances and aging effects, are generally due to the ambient temperature of the sensor module.

In the manufacture of a yaw rate sensor, it is known to take measures which improve the yaw rate sensor with respect to its zero offset error. Improving the sensors, which sense the movement of a vehicle, to the degree that they have only minor deviations from the operating or zero point at varying temperatures that differ from the operating temperature causes increased costs for sensors which is not tolerated in the mass production of vehicle industry. On the other hand, high demands with respect to control quality and, thus, the accuracy of sensing the actual movement of the vehicle are placed on driving dynamics control (ESP) which is meant to increase the safety of the vehicle and especially of vehicle occupants.

### BRIEF SUMMARY OF THE INVENTION

In view of the above, an object of the present invention is to provide a method and a sensor module which permit accurately determining a sensor signal over the entire working scope of a sensor sensing the movement of a vehicle.

In the method for establishing a table of correction values for detecting signal deviations in a sensor module of a vehicle, wherein at least one sensor, preferably at least two sensors, sensing the movement of the vehicle and at least one temperature sensor is provided, deviations from the zero points of the sensor are determined in a calibration mode when a temperature profile is executed, and the deviations from the zero points of the sensor are classified. The sensor adopts the inactive position in the calibration mode. Temperature values or classes are assigned to these deviations. The input quantity of the table is the deviation from the zero point, the zero offset error, and the temperature at which the zero offset error occurs. The temperature values or classes and the deviations or quantities representative of these deviations are memorized as correction values.

Another correction of the deviation from zero point is a learning process. A vehicle condition variable, preferably vehicle standstill, is sent from a driving dynamics controller to the sensor module by way of a serial data bus. The sensor module determines the temperature and the deviation from zero point of at least one sensor with respect to this vehicle condition variable and uses the deviation found with this vehicle condition variable as a correction value for the deviation stored at the said temperature value or in the temperature class.

For correction of the stored correction value, the mean value between the deviation stored in the table and the deviation found in the vehicle condition variable is calculated and stored as a new correction value in the table.

The vehicle standstill found in the driving dynamics controller can be determined by way of the variation of the yaw rate and/or the longitudinal and/or transverse acceleration, and/or the wheel rotational speeds. The vehicle standstill, as regards its values or its time variation, can satisfy defined conditions. More particularly, it may be demanded that this vehicle condition variable shows a certain constancy (within a scope of values within a time window), or that the change in the driving dynamics (from decelerated travel to vehicle standstill) is less than a threshold value.

To determine a corrected sensor signal in accordance with a sensed temperature in a sensor module of a vehicle, wherein at least one sensor, preferably at least two sensors, sensing the movement of the vehicle and at least one temperature sensor is provided, a table of correction values is established and memorized in the sensor module, the temperature of the sensor module is found out online by means of the temperature sensor during operation of the vehicle, a correction value is read out of the table in accordance with the value of the temperature, and the sensor signal is corrected with the correction value. The correction of the zero offset error renders the ESP functionality, such as the symmetry of the controlled vehicle movement when traveling through a curve, more precise.

For individual or several values, the correction of the sensor signal supplied by the sensor module is effected directly with the deviation which is stored in the table as a function of the temperature value or the temperature class according to the relation \dot{Ψ}_{Sensor-Module}=\dot{Ψ}_{Sensor}−\dot{Ψ}₀(τ). For other zero offset errors which are not stored in the table, correction values can be calculated by interpolation with appropriate methods.

Expediently, the temperature of the sensor module is continuously sensed during operation of the vehicle, and the correction value \dot{Ψ}(τ) for the sensor signal \dot{Ψ}_{Sensor-Module} is calculated according to the relation

$${\dot{ψ}}_{0} ( τ ) = {\dot{ψ}}_{0} ( {τ}_{n} ) + \frac{{\dot{ψ}}_{0} ( {τ}_{n + 1} ) - {\dot{ψ}}_{0} ( {τ}_{n} )}{{τ}_{n + 1} - {τ}_{n}} \times ( τ - {τ}_{n} )$$

$$for {τ}_{n} \leq τ < {τ}_{n + 1}$$

wherein \dot{Ψ}₀(τ)=correction value at the temperature sensed, \dot{Ψ}₀(τₙ)=correction value at the lower temperature value stored in the table of correction values, \dot{Ψ}₀(τₙ₊₁)=correction value at the higher temperature value stored in the table of correction values, τ=sensed temperature value, τₙ=lower temperature value, τₙ₊₁=higher temperature value. The so determined deviation from the operating point is stored in the table of correction values. The table of correction values is ‘filled up’ by way of this learning process and will contain more and more correction values with increasing time of operation. The zero offset errors of the sensor signal (which is sent to the superordinate control unit) will decrease with increasing correction values.

To reduce the effort in preparing the table of correction values, a linear variation of the deviations from zero point within a tolerance band is predetermined in the sensor, and preferably only two zero point deviations in a range of the maximum or minimum allowable temperature of the sensor module are found and stored as correction values. The further correction values are determined by interpolation with suitable methods, preferably according to the above-mentioned relation

$${\dot{ψ}}_{0} ( τ ) = {\dot{ψ}}_{0} ( {τ}_{n} ) + \frac{{\dot{ψ}}_{0} ( {τ}_{n + 1} ) - {\dot{ψ}}_{0} ( {τ}_{n} )}{{τ}_{n + 1} - {τ}_{n}} \times ( τ - {τ}_{n} )$$

$$for {τ}_{n} \leq τ < {τ}_{n + 1}$$

In a method of determining a corrected sensor signal in accordance with a sensed temperature in a sensor module of a vehicle, wherein at least one sensor, preferably at least two sensors, sensing the movement of the vehicle and at least one temperature sensor are provided, a deviation from the zero point of the sensor signal is determined in a calibration mode at a predetermined temperature, and the zero point of the sensor signal corrected by the deviation is stored at the temperature value as a correction value, the temperature of the sensor module is determined during operation of the vehicle, the correction value is read out of the memory, and the sensor signal is corrected with the individual correction value (offset value) according to the relation \dot{Ψ}_{Sensor-Module}=\dot{Ψ}_{Sensor}−\dot{Ψ}₀(τ). The present method permits effecting an offset of the zero point, that is sensed or measured preferably at or close to the operating temperature, by the deviation and permits storing it in the memory of the sensor module. The part of the zero offset error which is caused by component tolerances is compensated for by this calibration mode.

To establish further correction values, a driving dynamics controller sends a vehicle condition variable, especially a variable representative of the vehicle standstill, to the sensor module by way of a serial data bus. The sensor module determines in this vehicle condition variable the temperature and the deviation from the zero point of at least one sensor signal, and the deviation determined with respect to this vehicle condition variable is used as a correction value for the deviation stored at the temperature value or as a further correction value. The first and the additional correction values so found are stored in a table of correction values, preferably in a non-volatile memory. During operation of the vehicle, the temperature of the sensor module is continuously sensed, and the correction value \dot{Ψ}(τ) for the sensor signal \dot{Ψ}_{Sensor-Module} is calculated according to the relation

$${\dot{ψ}}_{0} ( τ ) = {\dot{ψ}}_{0} ( {τ}_{n} ) + \frac{{\dot{ψ}}_{0} ( {τ}_{n + 1} ) - {\dot{ψ}}_{0} ( {τ}_{n} )}{{τ}_{n + 1} - {τ}_{n}} \times ( τ - {τ}_{n} ) with n \geq 2$$

$$for {τ}_{n} \leq τ < {τ}_{n + 1}$$

and the calculated correction values are added to the table. The absolute zero point can be corrected at vehicle standstill according to the method described hereinabove.

The sensor module for determining a corrected sensor signal in accordance with a sensed temperature includes at least one sensor, preferably at least two sensors, sensing the movement of the vehicle, and at least one temperature sensor. Further, a signal processing unit and a digital output with a serial interface for a data bus is provided. In addition, the sensor module has a non-volatile memory for storing a table of correction values which is established according to the method of the present invention. At least one yaw rate sensor, one longitudinal and one transverse acceleration sensor and two temperature sensors are arranged in the sensor module.

### BRIEF DESCRIPTION OF THE DRAWINGS

FIG. 1 is a block diagram of a sensor module of the present invention.

FIG. 2 is a diagram showing the variation of the deviation from the operating point of a yaw rate sensor as a function of the temperature of the sensor according to embodiment 1 with n correction values.

FIG. 3 is a diagram showing the variation of the deviation from the operating point of a yaw rate sensor as a function of the temperature of the sensor of embodiment 2.

FIG. 4 is a diagram showing the variation of the deviation of FIG. 4 with initially two correction values (reference points [τₙ,\dot{Ψ}₀(τₙ)]).

FIG. 5 shows a diagram of FIG. 5 with further correction values (reference points [τₙ,\dot{Ψ}₀(τₙ)]).

FIG. 6 is a diagram showing the variation of the deviation from the operating point of a yaw rate sensor as a function of the temperature of the sensor according to embodiment 3.

FIG. 7 is a diagram of the offset corrected zero offset error.

FIG. 8 is a diagram according to FIG. 8 with further correction values (reference points).

### DETAILED DESCRIPTION OF THE PREFERRED EMBODIMENTS

Three different methods for the adjustment of the yaw rate sensor zero point are described which compensate for the deviation from the zero point (zero offset error) of the yaw rate sensor as a function of the ambient temperature. The methods are also appropriate for a zero point correction of the motion sensors arranged in the sensor module.

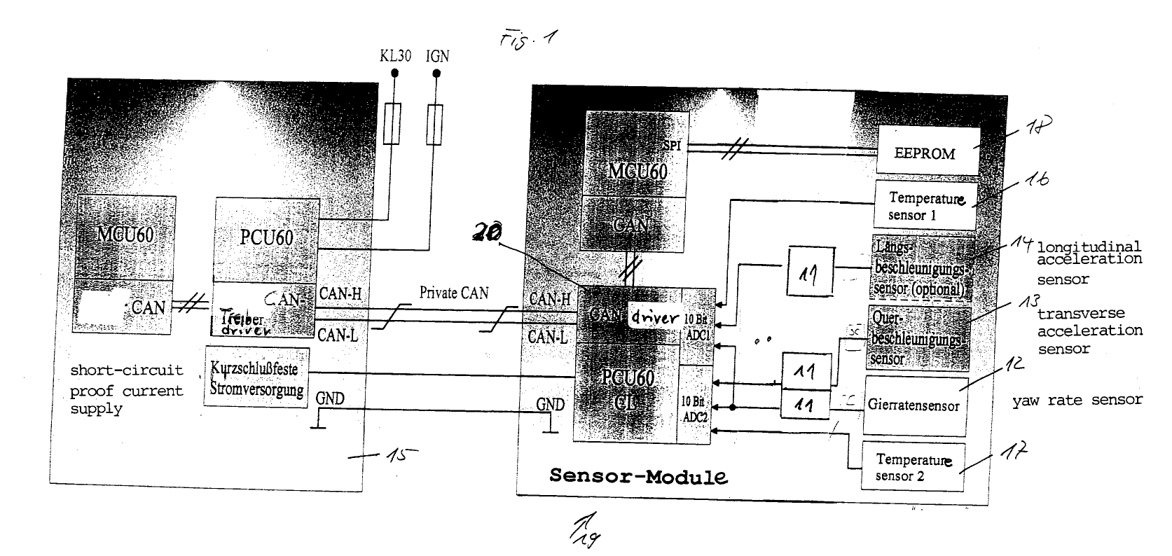

As shown in FIG. 1, the sensor module 19 includes a microcontroller 10, a signal conditioning stage 11, and, depending on the design, a yaw rate sensor 12, a transverse acceleration sensor 13, and a longitudinal acceleration sensor 14. Data generated in the sensor module is sent by way of a CAN serial interface 20 provided in the sensor module to a superordinate driving dynamics controller 15 for further data processing. Controller 15, in turn, supplies information about vehicle condition variables to the sensor module. The sensor module includes two temperature sensors 16, 17 (redundant design) and one non-volatile memory 18.

First Embodiment

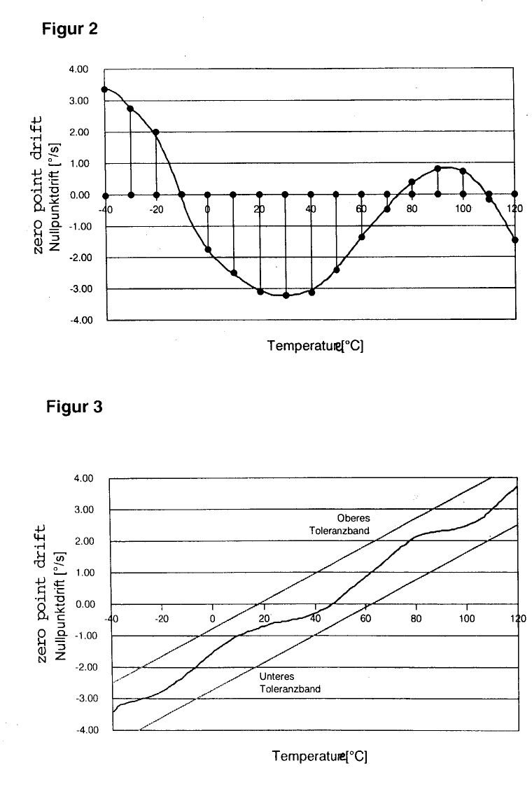

The embodiment of FIG. 2 shows a possible zero offset error of a yaw rate sensor as a function of the temperature of the sensor.

When the sensor module 19 is tested, it is switched into a special calibration mode. Subsequently, the sensor module 19 undergoes a fixed temperature profile in a temperature oven. The temperature and the deviation from the zero point of the yaw rate sensor is automatically sensed by the software in the sensor module 19. In this test, the deviation may also amount to 0°/s, i.e., when the temperature profile is executed, points are found where no zero offset error occurs at the measured temperature. The measured data is classified and stored in the non-volatile memory 18 of the sensor module 19. The calibration mode is then left to reside therein.

Thus, n-correction values are provided as reference points [τₙ,\dot{Ψ}₀(τₙ)] for the zero point correction of the yaw rate sensor, as illustrated in FIG. 2.

The temperature of the sensor module 19 is constantly measured during operation, and the zero offset error of the yaw rate sensor is calculated with this value with the aid of the stored reference points according to the following relation:

$${\dot{ψ}}_{0} ( τ ) = {\dot{ψ}}_{0} ( {τ}_{n} ) + \frac{{\dot{ψ}}_{0} ( {τ}_{n + 1} ) - {\dot{ψ}}_{0} ( {τ}_{n} )}{{τ}_{n + 1} - {τ}_{n}} \times ( τ - {τ}_{n} ) \\ for {τ}_{n} \leq τ < {τ}_{n + 1} \qquad equation 1$$

The yaw rate signal sent by way of the CAN-bus is calculated from the measured sensor signal and the calculated zero point of the yaw rate sensor according to the following relation:

\dot{Ψ}_{Sensor-Module}=\dot{Ψ}ₛₑₙₛₒᵣ−\dot{Ψ}₀(τ) equation 2

A slow zero point drift of the yaw rate sensor which is e.g. due to aging effects of the construction elements used may also be compensated for by means of this method.

When vehicle standstill is detected, for example, by way of evaluation of the wheel rotational speeds, the temperature of the sensor module 19 and the yaw rate is measured. These values are associated with one of the temperature classes stored in the non-volatile memory 18 (EEPROM). The mean value of the already stored zero point of the yaw rate sensor and of the newly measured value is determined by an appropriate method. The result is stored instead of the old value in the non-volatile memory 18 of the sensor module 19.

The sensor module 19 receives the information about the reliably detected vehicle standstill from a superordinate vehicle controller, preferably the driving dynamics controller.

The method described above may also be employed with respect to acceleration sensors during vehicle standstill, with the exception of the adaption of the data stored in the non-volatile memory 18. In these sensors, a correction of the values determined in the test during vehicle standstill is not possible because the signal of these sensors can become incorrect under the influence of acceleration due to gravity. The longitudinal acceleration sensor not only measures the vehicle longitudinal acceleration, portions of the acceleration due to gravity are superposed on the signal when driving uphill. Also, the transverse acceleration signal contains portions of the acceleration due to gravity when the vehicle is positioned along a roadway of transverse inclination. These disturbances must be found out and deducted by calculation from the measured signals in order to allow an adaption of the zero point values determined in the test.

Second Embodiment

A possible zero offset error of a yaw rate sensor as a function of the temperature of the sensor is illustrated in the embodiment of FIG. 3.

In contrast to the method of embodiment 1, the non-linearity of the zero offset error is limited, the zero offset error of the sensor, in dependence on temperature, still ranges only between a top and a bottom tolerance band.

When testing the sensor module 19, the said is switched into a special calibration mode. Subsequently, the sensor module 19 undergoes a fixed temperature profile in a temperature oven. Automatically, the temperature and the zero offset error of the yaw rate sensor is sensed by the software in the sensor module 19 at two reference points which ideally lie close to the minimum or close to the maximum of the allowable temperature range. The calibration mode is then left.

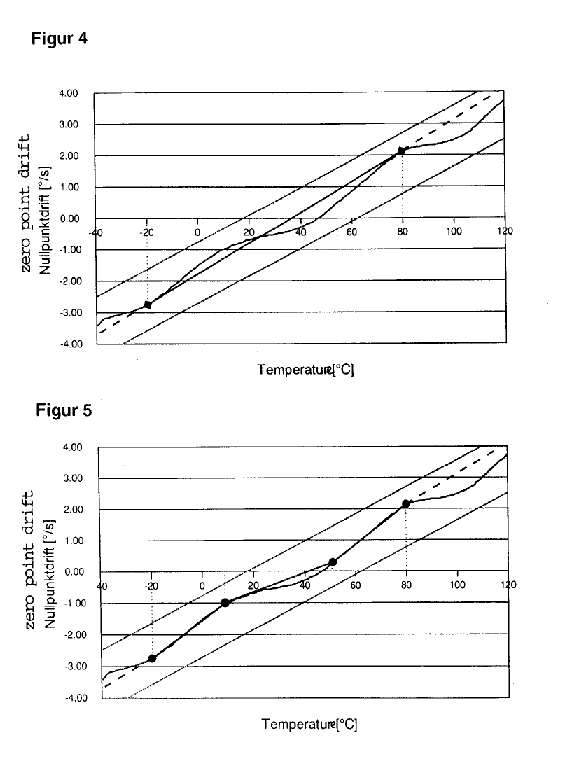

Thus, two correction values or reference points [τₙ,\dot{Ψ}₀(τₙ)] are initially available for the zero point correction of the yaw rate sensor, as illustrated in FIG. 4.

During operation of the vehicle, the temperature of the sensor module 19 is constantly measured, and the zero point of the yaw rate sensor is calculated with this value with the aid of the stored correction values points according to the following relation:

$${\dot{ψ}}_{0} ( τ ) = {\dot{ψ}}_{0} ( {τ}_{n} ) + \frac{{\dot{ψ}}_{0} ( {τ}_{n + 1} ) - {\dot{ψ}}_{0} ( {τ}_{n} )}{{τ}_{n + 1} - {τ}_{n}} \times ( τ - {τ}_{n} ) \\ for {τ}_{n} \leq τ < {τ}_{n + 1} \qquad equation 1$$

The yaw rate signal sent by way of the CAN-bus 20 is calculated from the measured sensor signal and the calculated zero point of the yaw rate sensor according to the following relation:

\dot{Ψ}_{Sensor-Module}=\dot{Ψ}ₛₑₙₛₒᵣ−\dot{Ψ}₀(τ) equation 2

A slow zero point drift of the yaw rate sensor may also be compensated for by means of this method, and the zero offset error of the yaw rate sensor may be minimized in the course of the time of operation of the sensor module 19.

When vehicle standstill is detected, the temperature of the sensor module 19 and the yaw rate is measured. These values are associated with one of the temperature classes stored in the non-volatile memory 18.

The mean value of the already stored zero point of the yaw rate sensor and of the newly measured value is determined by an appropriate method and stored in the non-volatile memory 18 of the sensor module 19 if there is already a correction value for the zero point in this temperature class. In case no valid zero point has been determined in this temperature class so far, the measured signal will be stored in the non-volatile memory 18 of the sensor module 19.

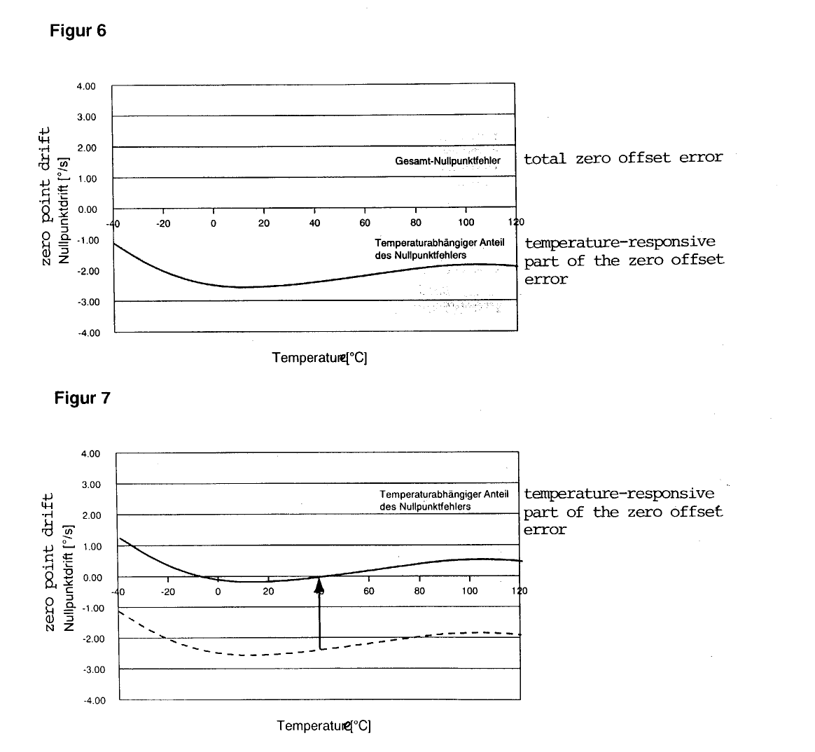

The zero offset error of the yaw rate signal will, thus, be reduced in the course of the time of operation of the sensor module 19 because more and more reference points will be filled up with measured correction values, as FIG. 5 shows. The sensor module 19 receives the information about the reliably detected vehicle standstill from a superordinate vehicle controller, preferably the driving dynamics controller.

As has already been described with respect to embodiment 1, the method described above can also be employed with respect to acceleration sensors during vehicle standstill, with the exception of the adaption of the data stored in the non-volatile memory 18, without additional calculation of disturbances. However, the said method is only applicable if the non-linearity of the zero offset errors of these sensors is low.

Third Embodiment

A possible zero offset error of a yaw rate sensor as a function of the temperature of the sensor is illustrated in the embodiment of FIG. 6.

The total zero offset error of the yaw rate sensor is comprised of a portion which is not responsive to temperature and is mainly dictated by component tolerances of the yaw rate sensor, and a temperature-responsive portion.

When testing the sensor module 19, the said is switched into a special calibration mode. Subsequently, the yaw rate which is measured at a defined temperature, that is ideally close to the operating temperature of the sensor module 19, is stored in the non-volatile memory 18 of the sensor module 19, and the calibration mode is left again.

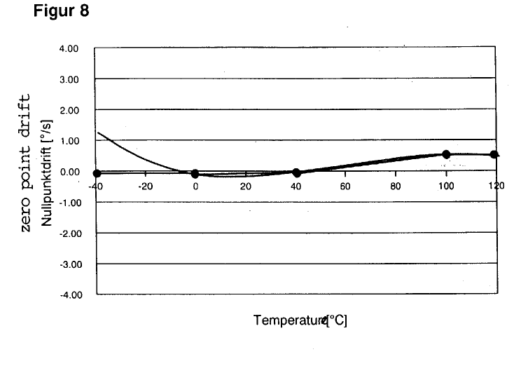

The portion of the zero offset error of the yaw rate sensor which is dictated by component tolerances of the sensors is compensated for by this calibration cycle. The remaining zero offset error is illustrated in FIG. 7.

Thus, only one value is initially available for the zero point correction of the yaw rate signal. The yaw rate signal sent by way of CAN-bus 20 is hence calculated from the measured sensor signal and the stored zero point of the yaw rate sensor according to the following relation:

\dot{Ψ}_{Sensor-Module}=\dot{Ψ}ₛₑₙₛₒᵣ−\dot{Ψ}₀(τ) equation 2

The value \dot{Ψ}₀(τ) is the only correction value stored in the non-volatile memory which is taken into consideration for the correction of the sensor signal.

As the operation of the sensor module 19 continues, a slow zero point drift of the yaw rate sensor may also be compensated for, and the zero offset error of the yaw rate sensor may be minimized in the course of the time of operation of the sensor module 19. The same adaption method as in embodiments 1 and 2 is used.

When vehicle standstill is detected, the temperature of the sensor module 19 and the yaw rate is measured. These values are associated with one of the temperature classes stored in the non-volatile memory 18.

The mean value of the already stored zero point of the yaw rate sensor and of the newly measured correction value is determined by an appropriate method and stored in the non-volatile memory 18 of the sensor module 19 if there is already a correction value for the zero offset error in this temperature class.

In case no valid zero offset error has been determined in this temperature class so far, the measured signal will be stored in the non-volatile memory 18 of the sensor module 19. The temperature of the sensor module will then be sensed continuously during operation of the vehicle, and the correction value \dot{Ψ}(τ) for the sensor signal \dot{Ψ}_{Sensor-Module} is calculated according to the relation

$${\dot{ψ}}_{0} ( τ ) = {\dot{ψ}}_{0} ( {τ}_{n} ) + \frac{{\dot{ψ}}_{0} ( {τ}_{n + 1} ) - {\dot{ψ}}_{0} ( {τ}_{n} )}{{τ}_{n + 1} - {τ}_{n}} \times ( τ - {τ}_{n} ) with n \geq 2$$

$$for {τ}_{n} \leq τ < {τ}_{n + 1}$$

and the table is supplemented with the calculated correction values.

The zero offset error of the yaw rate signal will, thus, be decreased in the course of the time of operation of the sensor module 19 because more and more reference points will be filled up with measured correction values (see FIG. 8).

The sensor module 19 receives the information about the reliably detected vehicle standstill from a superordinate vehicle controller also in this case.

The method of the present invention can be employed with respect to the yaw rate sensor because the yaw rate signal can be identified unambiguously during vehicle standstill. With respect to acceleration sensors, the said method may only be employed if signals of these sensors during vehicle standstill are separated from any disturbances which render the values incorrect as a result of acceleration due to gravity on an inclined roadway.

1. Method of establishing a table of correction values for detecting zero point deviations in a sensor module of a vehicle, wherein at least one sensor, preferably at least two sensors, sensing the movement of the vehicle and at least one temperature sensor is provided, characterized by the steps of
determining deviations from the zero points of the sensor in a calibration mode when passing through a temperature profile, and
classifying the deviations from the zero points of the sensor and associating temperature values or classes with the deviations.

2. Method as claimed in claim 1,
characterized in that the temperature values or classes and the deviations or quantities representative of these deviations are stored as correction values.

3. Method as claimed in claim 1 or 2,
characterized in that a vehicle condition variable is sent from a driving dynamics controller to the sensor module by way of a serial data bus, and the sensor module determines the temperature and the deviation from the zero point of at least one sensor with respect to this vehicle condition variable, and the deviation determined with respect to this vehicle condition variable is used as a correction value for the deviation stored at the temperature value or in the temperature class.

4. Method as claimed in any one of claims 1 to 3,
characterized in that for correction purposes, the mean value between the deviation stored in the table and the deviation established with respect to the vehicle condition variable is calculated.

5. Method as claimed in claim 3 or 4,
characterized in that the vehicle standstill is provided as vehicle condition variable.

6. Method as claimed in claim 5,
characterized in that the vehicle standstill is determined by way of the variation of the yaw rate and/or the longitudinal and/or transverse acceleration, and/or the wheel rotational speeds.

7. Method of determining a corrected sensor signal in accordance with a sensed temperature in a sensor module of a vehicle, wherein at least one sensor, preferably at least two sensors, sensing the movement of the vehicle and at least one temperature is provided,
characterized by the steps of
establishing a table of correction values with the method as claimed in any one of claims 1 to 6,
determining the temperature of the sensor module,
reading a correction value out of the table in accordance with the value of the temperature, and
correcting the sensor signal with the correction value.

8. Method as claimed in claim 7,
characterized in that the sensor signal is corrected directly with the deviation which is stored in the table as a function of the temperature value or the temperature class.

9. Method as claimed in claim 7 or 8,
characterized in that the correction of the sensor signal supplied by the sensor module is calculated according to the relation \dot{Ψ}_{Sensor-Moule}=\dot{Ψ}_{Sensor}\dot{Ψ}₀(τ).

10. Method as claimed in any one of claims 7 to 9,
characterized in that the correction values which are not stored in the table are calculated by way of an interpolation method.

11. Method as claimed in claim 1 or 10,
characterized in that the temperature of the sensor module is continuously sensed during operation of the vehicle, and the correction value \dot{Ψ}(τ) for the sensor signal \dot{Ψ}_{Sensor-Module} is calculated according to the relation
$${\dot{ψ}}_{0} ( τ ) = {\dot{ψ}}_{0} ( {τ}_{n} ) + \frac{{\dot{ψ}}_{0} ( {τ}_{n + 1} ) - {\dot{ψ}}_{0} ( {τ}_{n} )}{{τ}_{n + 1} - {τ}_{n}} \times ( τ - {τ}_{n} )$$
$$for {τ}_{n} \leq τ < {τ}_{n + 1}$$
wherein \dot{Ψ}₀(τ)=correction value at the temperature sensed, \dot{Ψ}₀(τ)=correction value at the lower temperature value stored in the table of correction values, \dot{Ψ}₀(τₙ₊₁)=correction value at the higher temperature value stored in the table of correction values, τ=sensed temperature value, τₙ=lower temperature value, τₙ₊₁=higher temperature value.

12. Method as claimed in claim 10 or 11,
characterized in that the calculated deviation from the zero point is stored in the table of correction values according to claims 1 to 6.

13. Method as claimed in any one of claims 1 to 12,
characterized in that at least two deviations in a range of the maximum or minimum allowable temperature of the sensor module is determined and stored as correction values when the variation of the deviations is predetermined linearly within a tolerance band.

14. Method of determining a corrected sensor signal in accordance with a sensed temperature in a sensor module of a vehicle, wherein at least one sensor, preferably at least two sensors, sensing the movement of the vehicle and at least one temperature sensor is provided,
characterized by the steps of
determining a deviation from the zero point of the sensor signal in a calibration mode at a predetermined temperature, and
storing the zero point of the sensor signal corrected by the deviation at the temperature value as a correction value,
determining the temperature of the sensor module during operation of the vehicle,
reading the correction value out of the memory, and
correcting the sensor signal with the correction value according to the relation \dot{Ψ}_{Sensor-Module}=\dot{Ψ}_{Sensor}−\dot{Ψ}₀(τ).

15. Method as claimed in claim 13,
characterized in that a driving dynamics controller sends a vehicle condition variable to the sensor module by way of a serial data bus, and the sensor module determines the temperature and the deviation from the zero point of at least one sensor signal with respect to this vehicle condition variable, and the deviation determined in this vehicle condition variable is used as a correction value for the deviation stored at the temperature value or is stored as a further correction value in the memory.

16. Method as claimed in claim 14,
characterized in that the temperature of the sensor module is continuously sensed during operation of the vehicle, and the correction value \dot{Ψ}(τ) for the sensor signal \dot{Ψ}_{Sensor-Module} is calculated according to the relation
$${\dot{ψ}}_{0} ( τ ) = {\dot{ψ}}_{0} ( {τ}_{n} ) + \frac{{\dot{ψ}}_{0} ( {τ}_{n + 1} ) - {\dot{ψ}}_{0} ( {τ}_{n} )}{{τ}_{n + 1} - {τ}_{n}} \times ( τ - {τ}_{n} ) with n \geq 2$$
$$for {τ}_{n} \leq τ < {τ}_{n + 1}$$
wherein \dot{Ψ}₀(τ)=correction value at the temperature sensed, \dot{Ψ}₀(τₙ)=correction value at the lower temperature value stored in the table of correction values, \dot{Ψ}₀(τₙ₊₁)=correction value at the higher temperature value stored in the table of correction values, τ=sensed temperature value, τₙ=lower temperature value, τₙ₊₁=higher temperature value.

17. Sensor module for determining a corrected sensor signal in accordance with a sensed temperature, wherein at least one sensor, preferably at least two sensors sensing the movement of the vehicle, and at least one temperature sensor is provided, and which further includes a signal processing unit and a digital output with a serial interface for a data bus,
characterized by a non-volatile memory for storing a table of correction values which is established according to the method as claimed in any one of claims 1 to 6.

18. Sensor module as claimed in claim 16,
characterized by at least one yaw rate sensor, one longitudinal and one transverse acceleration sensor, and two temperature sensors.
